(19) United States
(12) Patent Application Publication
(10) Pub. No.: US 2025/0307930 A1
(43) Pub. Date: Oct. 2, 2025

(54) TRANSACTION PLATFORM FOR INTELLECTUAL PROPERTY BASED ON BLOCKCHAIN

(71) Applicant: Ziyan YANG, Fuzhou (CN)

(72) Inventor: Ziyan YANG, Fuzhou (CN)

(21) Appl. No.: 19/238,369

(22) Filed: Jun. 14, 2025

Related U.S. Application Data
(63) Continuation of application No. PCT/CN2023/129226, filed on Nov. 2, 2023.

(30) Foreign Application Priority Data
Oct. 13, 2023 (CN) 202311325746.5

(51) Int. Cl. G06Q 40/04; G06Q 10/087; G06Q 20/40; G06Q 30/018; G06Q 50/18

(52) U.S. Cl. CPC G06Q 40/04; G06Q 10/087; G06Q 20/4014; G06Q 30/018; G06Q 50/184; G06Q 2220/00

(57) ABSTRACT

A transaction platform for intellectual property based on blockchain includes an identity authentication module, a smart contract module, a legal status authentication module and a contract verification module. The identity authentication module is configured to authenticate a user's identity and authorize user's behavior. The smart contract module is configured to allow a user to publish intellectual property products and customizably publish smart contracts, where the smart contracts provide basic information and transaction contract information, and the intellectual property products comprise ungranted products and granted product. The legal status authentication module is configured to authenticate authenticity and consistency of ownership information and legal status information of the intellectual property products published by the user. The contract verification module is configured to verify the basic information and the transaction contract information in the smart contracts during the transaction processes of the intellectual property products.

### CROSS-REFERENCE TO RELATED APPLICATIONS

This application is a continuation of International Patent Application No. PCT/CN2023/129226, filed on Nov. 2, 2023, which claims the benefit of priority from Chinese Patent Application No. 202311325746.5, filed on Oct. 13, 2023. The content of the aforementioned application, including any amendments thereto, is incorporated herein by reference in its entirety.

### TECHNICAL FIELD

This application relates to computer technologies, and more particularly to a transaction platform for intellectual property based on blockchain.

### BACKGROUND

Various intellectual creations, such as inventions, designs, literatures and artistic works, and signs, names and images used in business, can be regarded as intellectual properties owned by a certain person or organization. The intellectual properties, also known as ownerships of knowledge, refer to exclusive rights enjoyed by right holders in accordance with laws to results of their intellectual work and to marks and reputation of their business activities, which are generally only valid for a limited period of time.

Owing to the intellectual properties are property right granted by law, they can also be traded. Currently, the transaction platform for intellectual property is mainly based on blockchain technology to realize digitization of intellectual property assets through registration of intellectual property-related information on the blockchain, which greatly facilitates effective conducts of transactions.

However, transaction types provided on the transaction platform for intellectual property mainly focus on ownership transfers without opening of other transaction types, such as intellectual property license; besides, the transaction objects are limited to granted intellectual property, and intellectual property that are in the process of being authorized and not authorized are not allowed to be traded. For example, Chinese Patent Publication No. 109858909A published on Jun. 7, 2019 developed a transaction method, device, apparatus, and storage medium for intellectual property based on blockchain, where products need to be determined whether legal statuses are authorized before uploading; if the legal statuses are in unauthorized states, a prompt that it is not authorized and cannot be uploaded is returned; if the legal statuses are in authorized states, intellectual property blocks are generated according to unique numbers and intellectual property data. It can be seen that such application excludes transaction rights of intellectual property under examination, which is a restriction for both parties in the transaction.

In addition, technical-type intellectual property has a high pricing threshold because it priced according to value analysis index system of guidelines for value assessment in right transfer process, which greatly affects liquidity. A signing way of transaction contracts also brings about transaction opacity, which limits conversion rates of patent technology implementation to a certain extent.

### SUMMARY

In order to solve the above technical problems, this application a transaction platform for intellectual property based on blockchain. In this transaction platform, a user can publish intellectual property products and customizably publish smart contracts, and authenticate ownerships and legal grant statuses of the intellectual property, which ensures effectiveness of transaction objects, plentiful transaction types and transaction objects and transparent transaction, and greatly improves activity level of transactions.

A transaction platform for intellectual property based on blockchain is provided, comprising:
an identity authentication module;
a smart contract module;
a legal status authentication module;
an inventory management module;
a transaction module; and
a contract verification module;
wherein the identity authentication module is configured to authenticate a user's identity and authorize user's behavior;
the smart contract module is configured to allow a user to publish intellectual property products and customizably publish smart contracts, wherein the smart contracts provide basic information and transaction contract information, and the intellectual property products comprise ungranted products and granted product;
the legal status authentication module is configured to:
authenticate authenticity and consistency of ownership information and legal status information of the intellectual property products published by the user; and
after authentication is passed, complete publication of the intellectual property products or continue transaction processes of the intellectual property products;
the inventory management module is configured to add the intellectual property products and the smart contracts published by the user to shelves, and allow the user to perform shelve management;
the transaction module is configured to execute the transaction processes of the intellectual property products, wherein prices of the intellectual property products are adjusted according to a market actual situation;
the contract verification module is configured to verify the basic information and the transaction contract information in the smart contracts during the transaction processes of the intellectual property products; when the verification is passed, the transaction module updates transaction information of transaction objects, and continues to execute the transaction processes; and when the verification is unpassed, the transaction module terminates the transaction processes, updates legal statuses of the transaction objects, and delists the transaction objects.

In an embodiment, the shelve management comprise: listing of the intellectual property products and the smart contracts, displaying of the intellectual property products and the smart contracts, delisting of the intellectual property products and the smart contracts, update of the basic information and the transaction information of the intellectual property products.

In an embodiment, the basic information comprises:
names, application numbers, publication numbers and unique identifier of the intellectual property products;
types of the intellectual property products;
filing dates and publication dates of the intellectual property products;
legal statuses, status publication date and patent family information of the intellectual property products;
applicant information, applicant jurisdiction and patent grant territories of the intellectual property products; and
technical introduction and abstracts of the intellectual property products.

In an embodiment, the transaction contract information comprises:
seller information and buyer information;
transaction type information;
transaction scope description;
transaction fees and payment terms; and
other description;
wherein the transaction type information comprises application right transfer or ownership transfer, forms of license grant, license territorial scope and license period; and
the other description comprises agreements of bilateral rights and obligations and dispute resolutions.

This application at least has the following beneficial effects.

The user can customizably publish smart contracts during listing, where the smart contracts include the basic information and the transaction contract information. Relevant information can be authenticated and verifies through the legal status authentication module and the contract verification module, which ensures effectiveness of transaction objects, plentiful transaction types and transaction objects and transparent transaction, and greatly improves activity level of transactions.

Described above are only summary of this application. In order to understand the technical solutions of this application more clearly, implement according to content of this application, and make descriptions, objects, features and advantages of this application more obvious and understandable, specific embodiments are described below.

### BRIEF DESCRIPTION OF THE DRAWINGS

The present disclosure will be further described below with reference to the accompanying drawings

FIG. 1 shows a module structure of a transaction platform for intellectual property according to an embodiment of the present disclosure.

FIG. 2 is a schematic diagram of implement structure of the transaction platform according to an embodiment of the present disclosure.

FIG. 3 is a flow chart of listing on the transaction platform according to an embodiment of the present disclosure.

FIG. 4 is a flow chart of trading on the transaction platform according to an embodiment of the present disclosure.

### DETAILED DESCRIPTION OF EMBODIMENTS

The present disclosure provides a transaction platform for intellectual property based on blockchain. A user can publish intellectual property products and customizably publish smart contracts, and authenticate ownerships and legal grant statuses of the intellectual property, which ensures effectiveness of transaction objects, plentiful transaction types and transaction objects and transparent transaction, and greatly improves activity level of transactions.

The present disclosure has an overall thinking as follows: based on blockchain technologies, the user can publish the intellectual property products, customizably publish the smart contracts, and customize basic information and transaction contract information of the intellectual property products; transaction types are expanded in transaction information: based on single listing and ownership transfer, transactions of granted licenses are added; in the process of transaction, a legal status authentication module verifies granted statuses and ownership, which ensures authenticity and consistency of ownership information and legal status information of the intellectual property products; and trading capacity of the intellectual property products that in ungranted statuses or under application are provided during application period. In addition, open market transactions are realized through public information queries of the intellectual property, the smart contracts and asset on-chaining, so that pricing is determined by the market, which lowers transaction threshold. On-chaining transaction prices and transaction records are transparent.

### Embodiments

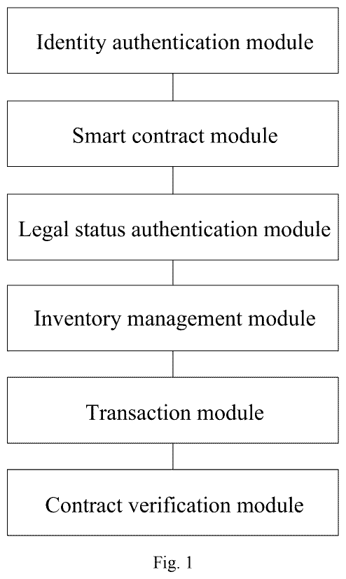

Referring to FIG. 1, a transaction platform for intellectual property based on blockchain includes an identity authentication module, a smart contract module, a legal status authentication module, an inventory management module a transaction module and a contract verification module.

The identity authentication module is configured to authenticate a user's identity and authorize user's behavior.

The smart contract module is configured to allow a user to publish intellectual property products and customizably publish smart contracts, where the smart contracts provide basic information and transaction contract information, and the intellectual property products include ungranted products and granted product, where the ungranted products refer to the intellectual property products that are under application and with uncompleted examination, and the granted product refer to the intellectual property products that are granted after examination by the intellectual property department.

The legal status authentication module is configured to:
authenticate authenticity and consistency of ownership information and legal status information of the intellectual property products published by the user; and
after authentication is passed, complete publication of the intellectual property products or continue transaction processes of the intellectual property products.

The inventory management module is configured to add the intellectual property products and the smart contracts published by the user to shelves, and allow the user to perform shelve management.

The transaction module is configured to execute the transaction processes of the intellectual property products, where the transaction processes include application right transfer processes, ownership transfer processes, license grant processes and auction processes. Generally, it is noted that the intellectual property products on-chaining can be traded again within validity period, and transaction types include ownership transfer, granted license and auction.

The contract verification module is configured to verify the basic information and the transaction contract information in the smart contracts during the transaction processes of the intellectual property products. When the verification is passed, the transaction module updates transaction information of transaction objects, and continues to execute the transaction processes. When the verification is unpassed, the transaction module terminates the transaction processes, updates legal statuses of the transaction objects, and delists the transaction objects.

It is noted that the term “publish” herein refers to a digitizing process of real-world asset (RWA), including direct listing of the intellectual property products, publication on the platform of the on-chaining intellectual property products in a trusteeship mode, or independent token minting and release of non-fungible token (NFT) products under listing or on-chaining of the intellectual property products.

In an embodiment, the shelve management include: listing of the intellectual property products and the smart contracts, displaying of the intellectual property products and the smart contracts, delisting of the intellectual property products and the smart contracts, update of the basic information and the transaction information of the intellectual property products.

In an embodiment, the basic information includes:
names, application numbers, publication numbers and unique identifier of the intellectual property products;
types of the intellectual property products;
filing dates and publication dates of the intellectual property products;
legal statuses, status publication date and patent family information of the intellectual property products;
applicant information, applicant jurisdiction and patent grant territories of the intellectual property products; and
technical introduction and abstracts of the intellectual property products.

In an embodiment, the transaction contract information includes:
seller information and buyer information;
transaction type information;
transaction scope description;
transaction fees and payment terms; and
other description;
where the transaction type information includes application right transfer or ownership transfer, forms of license grant, license territorial scope and license period; and
the other description includes agreements of bilateral rights and obligations and dispute resolutions.

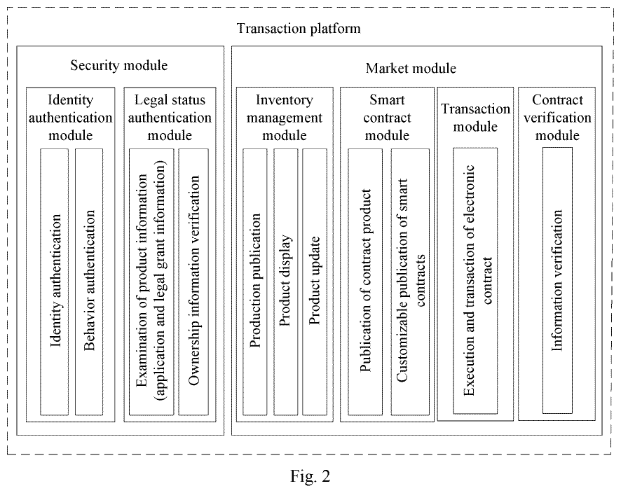

Referring to FIG. 2, when a specific structure of the transaction platform of the present disclosure is realized, the identity authentication module and the legal status authentication module are consolidated into a security module, and the inventory management module, the smart contract module, the contract verification module and the transaction module are consolidated into a market module.

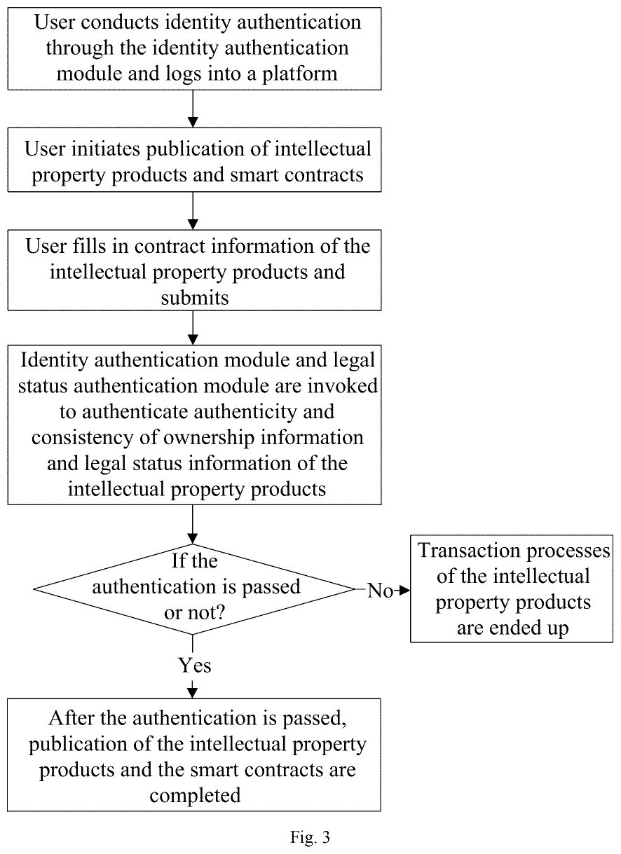

Referring to FIG. 3, based on the transaction platform, publication processes of the user is described as follows.

The user conducts identity authentication through the identity authentication module and logs into the platform.

The user initiates publication of the intellectual property products and the smart contracts.

The user fills in the contract information of the intellectual property products and submits.

The identity authentication module and the legal status authentication module are invoked to authenticate authenticity and consistency of the ownership information and the legal status information of the intellectual property products.

After the authentication is passed, publication of the intellectual property products and the smart contracts are completed, otherwise the transaction processes of the intellectual property products are ended up.

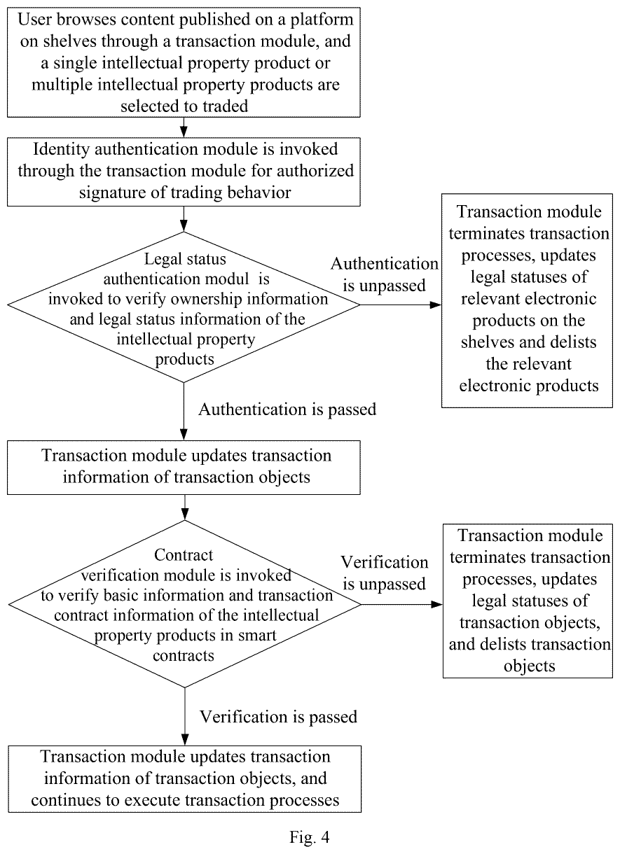

Referring to FIG. 4, based on the transaction platform, transaction processes of the user is described as follows.

The user browses content published on the platform on the shelves, and a single intellectual property product or multiple intellectual property products are selected to traded.

The identity authentication module is invoked for authorized signature of trading behavior, that is behavior authentication.

The legal status authentication module is invoked to verify the ownership information and the legal status information of the intellectual property products. For example, after the intellectual property products are listed, as time goes by, the ungranted products may be granted or rejected, while the granted products may lose rights due to unpaid fees, or ownership and application rights may have been transferred, therefore, the ownership information and the legal status information need to be verified again. When the verification is passed, the transaction module updates transaction information of transaction objects, and continues to execute the transaction processes. When the verification is unpassed, the transaction module terminates the transaction processes, updates legal statuses of relevant electronic products on the shelves and delists the relevant electronic products.

The contract verification module is invoked to verify the basic information including application numbers, publication numbers and unique identifier, legal statuses, status publication date and patent family information and applicant jurisdiction, and the transaction contract information including account balance, total contract amount, time and terms of risks. When the verification is passed, the transaction module updates transaction information of transaction objects, and continues to execute the transaction processes. When the verification is unpassed, the transaction module terminates the transaction processes, updates legal statuses of the transaction objects, and delists the transaction objects.

In summary, one or more embodiments of the present disclosure has at least the following beneficial effects. The user can customizably publish smart contracts during listing, where the smart contracts include the basic information and the transaction contract information. Relevant information can be authenticated and verifies through the legal status authentication module and the contract verification module, which ensures effectiveness of transaction objects, plentiful transaction types and transaction objects and transparent transaction, and greatly improves activity level of transactions.

Described above are specific embodiments of the present disclosure. It should be noted by those of ordinary skill in the art that the specific embodiments described herein are only illustrative rather than limiting the disclosure. It should be noted that equivalent modification and transformations made by those of ordinary skill in the art without departing the spirit of the present disclosure, shall fall within the scope of this application defined by the appended claims.

What is claimed is:

1. A transaction platform for intellectual property based on blockchain, comprising:
an identity authentication module;
a smart contract module;
a legal status authentication module;
an inventory management module;
a transaction module; and
a contract verification module;
wherein the identity authentication module is configured to authenticate a user's identity and authorize user's behavior;
the smart contract module is configured to allow a user to publish intellectual property products and customizably publish smart contracts, wherein the smart contracts provide basic information and transaction contract information, and the intellectual property products comprise ungranted products and granted product;
the legal status authentication module is configured to:
authenticate authenticity and consistency of ownership information and legal status information of the intellectual property products published by the user; and
after authentication is passed, complete publication of the intellectual property products or continue transaction processes of the intellectual property products;
the inventory management module is configured to add the intellectual property products and the smart contracts published by the user to shelves, and allow the user to perform shelve management;
the transaction module is configured to execute the transaction processes of the intellectual property products, wherein the transaction processes comprise application right transfer processes, ownership transfer processes, license grant processes and auction processes; and
the contract verification module is configured to verify the basic information and the transaction contract information in the smart contracts during the transaction processes of the intellectual property products; when the verification is passed, the transaction module updates transaction information of transaction objects, and continues to execute the transaction processes; and when the verification is unpassed, the transaction module terminates the transaction processes, updates legal statuses of the transaction objects, and delists the transaction objects.

2. The transaction platform of claim 1, wherein the shelve management comprise: listing of the intellectual property products and the smart contracts, displaying of the intellectual property products and the smart contracts, delisting of the intellectual property products and the smart contracts, update of the basic information and the transaction information of the intellectual property products.

3. The transaction platform of claim 1, wherein the basic information comprises:
names, application numbers, publication numbers and unique identifier of the intellectual property products;
types of the intellectual property products;
filing dates and publication dates of the intellectual property products;
legal statuses, status publication date and patent family information of the intellectual property products;
applicant information, applicant jurisdiction and patent grant territories of the intellectual property products; and
technical introduction and abstracts of the intellectual property products.

4. The transaction platform of claim 3, wherein the transaction contract information comprises:
seller information and buyer information;
transaction type information;
transaction scope description;
transaction fees and payment terms; and
other description;
wherein the transaction type information comprises application right transfer or ownership transfer, forms of license grant, license territorial scope and license period; and
the other description comprises agreements of bilateral rights and obligations and dispute resolutions.
